(19) United States
(12) Patent Application Publication
(10) Pub. No.: US 2015/0034550 A1
(43) Pub. Date: Feb. 5, 2015

(54) Filter Element for Liquid Filtration

(71) Applicant: MANN+HUMMEL GMBH, Ludwigsburg (DE)

(72) Inventors: Jobst Eisengraeber-Pabst, Benningen a. N (DE); Pius Trautmann, Stuttgart (DE)

(21) Appl. No.: 14/448,384

(22) Filed: Jul. 31, 2014

(30) Foreign Application Priority Data
Jul. 31, 2013 (DE) 10 2013 012 668.1

(51) Int. Cl. B01D 39/18; B32B 37/24; B01D 29/11; B32B 37/18; B01D 29/56; B01D 29/01

(52) U.S. Cl. CPC B01D 39/18; B01D 29/56; B01D 29/016; B01D 29/11; B32B 37/182; B32B 37/24; B32B 2037/243; B32B 2305/026; B32B 2307/726
USPC 210/490; 210/489; 156/60

(57) ABSTRACT

A filter element for liquid filtration has a first layer and a second layer. The first and second layers are arranged one behind the other in the direction of flow. The first layer is a filter layer of cellulose, and the second downstream layer is a nonwoven of plastic fibers, wherein the second layer has a smaller thickness than the first layer.

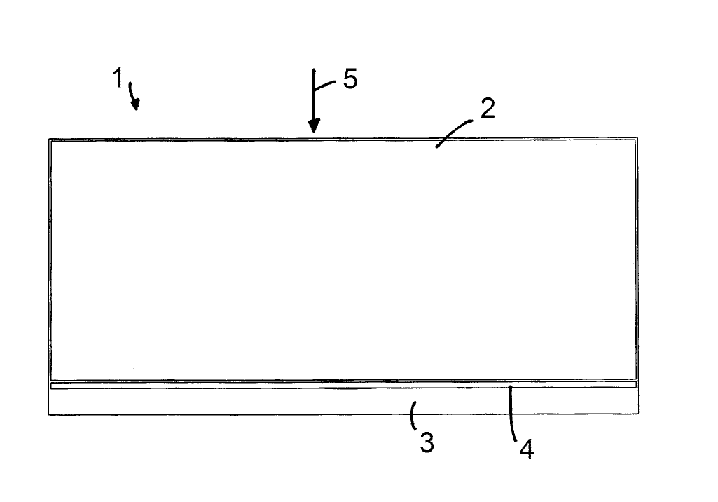

### CROSS-REFERENCE TO RELATED APPLICATION

This application claims the benefit of German patent application No. 10 2013 012 668.1, filed: Jul. 31, 2013, the entire contents of the aforesaid German patent application being incorporated herein by reference.

### BACKGROUND OF THE INVENTION

The invention relates to a filter element for liquid filtration, wherein the filter element has two layers of different media which are arranged one behind the other in the direction of flow.

Single-layer or multi-layer filter elements for liquid filtration which consist of cellulose or synthetic fibers are known. In the case of multi-layer filter elements, the different layers can differ either in terms of their constituents or their structure in one or more aspects. Thus, two-layer or multi-layer liquid filter elements are known in which the layers are constructed from different materials. Furthermore, single-layer liquid filter elements provided on one side with a micro-fiber layer, which, however, has no measurable thickness, are also known in the art; such a filter element is described in DE 102 45 124 A1.

### SUMMARY OF THE INVENTION

It is an object of the invention to propose a filter element for liquid filtration that has a simple structure characterized by high aging resistance to aggressive liquids.

This object is achieved according to the invention in that the first layer forms a filter layer comprising cellulose, and the second downstream layer is a nonwoven comprising plastic fibers, wherein the second layer has a smaller thickness than the first layer.

The dependent claims disclose useful further embodiments.

The filter element can be used for liquid filtration, for example, in an oil or fuel filter. The filter element is suitable in general for use in liquid filters, in particular for aggressive media which potentially are able to damage the material of the filter element. For example, when used over prolonged periods, oil can exhibit a decreasing pH value and thus can become chemically aggressive. By means of the filter element according to the invention, use in connection with relatively aggressive liquids to be filtered is also possible.

The filter element has a first layer and a second layer; the first and second layers are arranged parallel to one another and are constructed from different media. The flow passes perpendicular to the layer plane through the two layers which are arranged one behind the other in the direction of flow of the liquid so that the liquid fluid to be cleaned flows first through the first layer and subsequently through the second layer. The filter element preferably consists of only two layers; however, an embodiment having more than two layers is optionally also possible.

The first layer of the filter element forms a filter layer that consists of cellulose or has a cellulose content of at least 50%. The first layer serves for filtering the liquid.

The second layer which is connected to the first layer and which is located on the downstream side of the first layer is formed as a nonwoven that comprise plastic fibers and has a smaller thickness than the first layer. In case of filter elements having more than two layers, the second layer is preferably also located on the downstream side; however, embodiments are also possible in which the second layer comprising the plastic fibers is directly connected to the first, upstream layer and another downstream layer is arranged downstream of the second layer.

The second downstream layer comprising the plastic fibers has the advantage of a significantly better chemical resistance compared to the first layer having the cellulose content. The primary task of the second downstream layer is not to filter the liquid, but rather to prevent that cellulose particles from the first upstream layer, which become detached or are washed out by the liquid to be cleaned, are entrained in the liquid flow and can pass through the filter element. Thus, it is prevented that cellulose particles can accumulate in the liquid to be cleaned. The plastic fibers that are contained in the downstream nonwoven have a higher chemical resistance to aggressive media than the cellulose particles in the first upstream layer.

The downstream layer comprising the plastic fibers has a smaller thickness than the upstream layer which assumes the function of filtering the liquid. Thus, it is ensured that at a required filtration performance, the installation space needed for the filter element is not larger or only insignificantly larger. Overall, even with the improved chemical resistance, the filter element is still very compact.

Optionally, the thickness of the first layer can be multiple times the thickness of the second downstream layer. For example, the thickness of the first layer is three times, four times, five times or more the thickness of the second layer. According to another advantageous embodiment, the downstream layer has a maximum thickness of 0.25 mm, and the thickness of the downstream layer is within a value range of from 0.1 mm to 0.2 mm, for example. In contrast, the first upstream layer has a greater thickness which can be multiple times the layer thickness of the downstream layer. Due to the relatively small thickness of the second layer, it is ensured that the required installation space of the filter element is only insignificantly increased by the downstream layer. However, at the same time, the downstream layer constitutes an independent layer in contrast to simply applying plastic fibers onto the first layer.

The downstream layer having the plastic fibers can also improve the mechanical strength of the filter element. The downstream layer, at least in the layer plane, i.e., orthogonal to the direction of flow, has a higher tensile strength than the upstream filter layer. As a result, the filter element is able to absorb overall higher tensile forces as would be possible with only the filter layer from cellulose fibers.

Since the plastic fibers in the second layer primarily do not have a filtration function for the liquid but rather a retaining function for cellulose particles from the first layer, it is sufficient to provide plastic fibers having a fiber diameter above the nanometer range, thus in the micrometer range, in particular in a range between 1 μm and 500 μm, preferably 1 μm and 100 μm. However, larger or smaller fiber diameters can optionally also be provided in the second layer.

According to an advantageous embodiment, the plastic fibers in the second downstream layer are embodied to be oil-resistant. This enables use of the filter element in oil filters, in particular for motor vehicles. The plastic fibers are made, for example, from polyester, polyamide, PPS (polyphenylene sulfide) or another plastic material.

The downstream layer comprising the nonwoven made from plastic fibers can be produced using the spunbond method. However, production using the meltblown method is basically also possible.

According to another advantageous embodiment, the downstream layer has a weight per surface area of 10 g/m² to 50 g/m². In particular in combination with a thickness of the downstream layer in the range of from 0.1 mm to 0.2 mm, this layer meets the requirements in terms of chemical aging resistance, improvement of the tensile strength in the layer plane, and little additional installation space.

According to another useful embodiment, the first and the second layers are connected to one another; this can be done by laminating the second layer onto the first layer, for example by means of adhesive bonding, ultrasonic welding, thermo-calandering etc. Through said connection, on the one hand, the risk of false flows is reduced and, on the other, the strength of the overall composite of the two layers is improved.

According to yet another useful embodiment, the first and the second layers are impregnated. Producing the filter element preferably takes place in a plurality of method steps, wherein in a first method step, the first and the second layer are first connected to one another, and in a subsequent second method step, the first and the second layer are impregnated together. Impregnating thus takes place only after connecting both layers to one another, which has the advantage that the connection layer between the two layers is also impregnated and thus is better protected against aggressive media. In addition, jointly impregnating facilitates the connection of the two layers to each other.

Different geometrical shapes of the filter element can be considered. According to a first useful embodiment, the filter element is plate-shaped, and the first and the second layers are flat plates or layers. According to a second useful embodiment, the filter element is cylindrical or hollow-cylindrical and the flow passes radially therethrough, in particular radially from the outside to the inside; in this case, the downstream layer comprising the plastic fibers is located on the radially inner side of the filter element.

According to yet another useful embodiment, the layers in the filter element are pleated. The pleated embodiment can be used for flat (plate-shaped) as well as for cylindrical or hollow-cylindrical filter elements. The pleats of both layers engage each other so that the cellulose layer is supported by the second layer comprising plastic fibers and having a higher strength.

The first layer and/or the second layer can have embossings. Through the higher strength of the plastic fiber layer compared to the first layer having cellulose content, the total stiffness of the filter element is improved. This makes it possible to reduce a proportion of plastic fibers potentially present in the first layer and to increase the cellulose content, as a result of which the embossing characteristics of the filter medium are improved and the flow resistance is reduced.

### BRIEF DESCRIPTION OF THE DRAWINGS

Further advantages and useful embodiments are apparent from the claims, the detailed description, and from the only drawing in which a filter element for liquid filtration is illustrated in cross-section.

### DESCRIPTION OF PREFERRED EMBODIMENTS

The filter element 1 illustrated in the FIGURE is used for filtering liquid, for example, in fuel filters or oil filters for motor vehicles. The plate-shaped filter element 1 is configured in two layers and has a first layer 2, primarily used for filtering the liquid, and an adjoining second layer 3, primarily having the function of stabilizing the first layer 2 and of retaining detached filter particles from the first layer 2 so as to prevent detached filter particles from being carried along in the cleaned liquid flow. The liquid to be cleaned flows in the direction of flow 5 through the filter element 1. The first filter layer 1 is located on the upstream side and the second layer 3 on the downstream side. The two layers 2 and 3 are connected to one another via an adhesive layer 4.

The first layer 2 has a thickness that is significantly greater than that of the second layer 3; the second layer 3 preferably has a thickness in the range between 0.1 mm and 0.2 mm, whereas the first layer 2 has a thickness that is, for example, five times the thickness of the second layer 3.

The first layer 2 has the function of filtering the liquid and has a high cellulose content of at least 50%; the first layer 2 can optionally consist of 100% cellulose. The second layer 3 has the task of stabilizing the first layer 2 and, in addition, of collecting cellulose particles that are pulled out of the first layer 2 so as to avoid that the particles are washed out and carried along in the liquid flow. The second layer 3 is formed as a nonwoven having plastic fibers and is in particular produced using the spunbond method. The plastic fibers are, for example, fibers from polyester, polyamide or PPS (polyphenylene sulfide).

For producing the filter element 1, the two layers 2 and 3 are first adhesively bonded to each other via the adhesive layer 4. Subsequently, the entire filter element 1 is impregnated, which has the advantage that the adhesive layer 4 is also provided with impregnation and therefore is better protected against aggressive media.

While specific embodiments of the invention have been shown and described in detail to illustrate the inventive principles, it will be understood that the invention may be embodied otherwise without departing from such principles.

What is claimed is:

1. A filter element for liquid filtration, the filter element comprising:
a first layer and a second layer, the second layer arranged downstream of the first layer in a direction of flow of a liquid through the filter element;
wherein the first layer is a filter layer comprising cellulose;
wherein the second layer is a nonwoven comprising plastic fibers, wherein the second layer has a thickness that is smaller than a thickness of the first layer.

2. The filter element according to claim 1, wherein the plastic fibers of the second layer comprise oil-resistant plastic fibers.

3. The filter element according to claim 1, wherein the plastic fibers of the second layer comprise polyester fibers; polyamide fibers; or PPS (polyphenylene sulfide) fibers.

4. The filter element according to claim 1, wherein the second layer is a spunbond layer.

5. The filter element according to claim 1, wherein the thickness of the second layer is maximally 0.25 mm.

6. The filter element according to claim 5, wherein the thickness of the second layer is in a range of 0.1 mm to 0.2 mm.

7. The filter element according to claim 1, wherein the second layer has a weight per surface area of 10 g/m² to 50 g/m².

8. The filter element according to claim 1, wherein the second layer is adhesively bonded to the first layer.

9. The filter element according to claim 1, wherein the first layer and the second layer are impregnated.

10. The filter element according to claim 9, wherein the first and second layers are impregnated together.

11. The filter element according to claim 9, wherein the first and second layers are bonded to each other with a connection layer and wherein the first and second layers together with the connection layer are impregnated together.

12. The filter element according to claim 11, wherein the connection layer is an adhesive layer.

13. The filter element according to claim 1, wherein the first and second layers are pleated.

14. The filter element according to claim 1, wherein the filter element is hollow-cylindrical or plate-shaped.

15. The filter element according to claim 1, further comprising a support tube integrated in the filter element.

16. A method for producing a filter element according to claim 1, the method comprising:
connecting a first layer that is a filter layer comprising cellulose and a second layer that is a nonwoven comprising plastic fibers to each other;
subsequently impregnating the first and second layers together.

14. An oil filter comprising a filter element according to claim 1.
